(19) United States
(12) Patent Application Publication
(10) Pub. No.: US 2008/0015311 A1
(43) Pub. Date: Jan. 17, 2008

(54) Polyurea-polyurethane molded articles and process for their production

(76) Inventors: Norbert Eisen, Koln (DE); Stephan Schleiermacher, Pulheim (DE)

Correspondence Address: BAYER MATERIAL SCIENCE LLC, 100 BAYER ROAD, PITTSBURGH, PA, 15205, US

(21) Appl. No.: 11/825,719

(22) Filed: Jul. 9, 2007

(30) Foreign Application Priority Data
Jul. 12, 2006 (DE) 102006032187.1

(51) Int. Cl. C08G 18/28

(52) U.S. Cl. 524/590; 525/457

(57) ABSTRACT

Polyurea-polyurethane molded articles are produced by reacting organic polyisocyanates, polyols and aromatic amine chain extenders with alkylthio groups with improved impact strength, heat resistance, rigidity (quantified via the flexural modulus) and length of the injection time

### BACKGROUND OF THE INVENTION

The invention relates to polyurea-polyurethane molded articles and a process for the production of cellular or compact polyurea-polyurethane molded articles by reacting organic polyisocyanates, polyols and aromatic amine chain extenders with alkylthio groups. These molded articles have improved impact strength, heat resistance, rigidity (quantified via the flexural modulus) and length of the injection time.

It is generally known to produce molded articles from polyurethane foams (e.g., DE-A 119 68 64) by feeding a reactive and foamable mixture of organic polyisocyanates, compounds with groups reactive to isocyanate groups and the usual auxiliaries and additives into a closed mold. With a simple process setting, i.e., with a long fill time and without using abrasive fillers, such molded articles could hitherto be obtained only if a high impact strength, high rigidity and a high heat resistance did not have to be achieved.

DE-A 1 694 138 describes highly crosslinked integral rigid foams with high heat resistance and rigidity. The impact strengths of these foams are however insufficient. Even with clearly denser systems (above 1800 kg/m³), as described in EP-A 0 265 781, there is still a need for improvement in the impact strength with regard to applications such as those for the transport sector.

Largely linear polyurethane systems are distinguished by high impact strengths. DE-A 2 513 817 describes polyurethanes of higher molecular weight polyhydroxyl compounds and 1,4-butanediol or 1,2-ethanediol as chain extenders with good elasticity. It is, however, disadvantageous that a longer heating of the freshly produced molded articles is necessary to guarantee a good heat resistance and impact strength. This requires investment in spacious ovens or chambers and prolongs the time required for production. Furthermore, the too low flexural moduli can only be increased by adding abrasive fiber fillers to the starting components. As a result, machine components must be strengthened, different warp behavior of cured molded articles can occur as a function of direction, and the requirements for maintenance of machine components susceptible to wear are higher.

In the sector of linear and low crosslinking systems, numerous developments result in the heat resistance of the molded articles increasing by the extent possible by heating. In the classic formulation, isocyanates and isocyanate prepolymers which can also have carbodiimide and/or uretoneimine groups (DE-A 2 622 951, DE-A 101 60 375) are reacted with formulations which contain a high level of amines. Dialkyltoluene diamines are mostly used for this. In addition, amine-terminated polyethers (DE-A 31 47 736) are also used. In all cases, the systems are very reactive, so that only very short fill times of less than two seconds are possible. Moreover, the molded articles have low flexural moduli which can only be raised by the use of fillers and which entail the disadvantages already mentioned in the previous paragraph. Furthermore, heating after demolding is also necessary with these molded articles in order to achieve the desired properties and consequently an additional expenditure of thermal energy and corresponding storage capacity is required.

As an alternative to the highly reactive amines, it is proposed in DE-A 34 07 931 to allow the amines to be produced in situ by the water-isocyanate reaction. A lot of carbon dioxide as coupling product however is necessarily formed with this process. Only high clamping forces and a very tight-closing mold parting line can keep the carbon dioxide produced dissolved in the reacting liquid and prevent the reaction mixture from spurting from the mold as foam. For these reasons, this processing method is only used in niche applications.

EP-A 0 647 666 describes another route. Finished polyureas and polyurea-polyurethanes are granulated, converted to a liquid form and the modified isocyanate thus obtained is reacted with formulations reactive to isocyanates. The direct production of such polyureas or polyurea-polyurethanes on an industrial scale would require expenditures that would be uneconomical due to the number of synthesis steps. If waste materials were recycled, the purchaser would be dependant upon coincidentally occurring quantities of waste. Moreover, if large quantities of uniform waste materials are not obtained, the products would not have a constant quality. Both, however, are indisputable prerequisites for use in high-quality molded articles, so the method disclosed in EP-A 0 647 666 is not suitable for industrial application.

In addition to the in situ production of amines and the isocyanatolysis of ureas, it is also known to use amines with low reactivity. In DE-A 1 216 538, the aromatic amines 4,4′-methylene-bis-(2-fluoroaniline), 4,4′-methylene-bis-(2-chloroaniline), 4,4′-methylene-bis-(2-bromoaniline), 4,4′-methylene-bis-(2-nitroaniline) and 4,4′-diamino-3,3′-dichlorodiphenyl are used. There are, however, two serious disadvantages for its economic use. First, their effect, prejudicial to health, requires costly safety precautions and protective measures. Second, they prolong the reaction rates of the systems to an uneconomically long duration of up to 15 and even 69 minutes. In contrast to this, the reaction times of the systems in EP-A 0 026 915 which are based on sterically hindered diaminodiphenylmethanes are, at two to four seconds, too short to be able to manufacture molded articles with high shot weights.

### SUMMARY OF THE INVENTION

The object of the present invention was therefore to provide polyurethane molded articles that can be produced in optimal fill times (more than 6 seconds) for large shot weights having high flexural moduli (above 2000 N/mm²), high impact strengths (greater than 60 kJ/m², preferably greater than 80 kJ/m²) and high heat resistance (above 100° C.).

Surprisingly, this object could be achieved by filler-free polyurea-polyurethane molded articles which are produced with a polyol component satisfying specific compositional requirements.

### DETAILED DESCRIPTION OF THE PRESENT INVENTION

The present invention relates to polyurea-polyurethane molded articles which have a molar density ratio of knot density to urea group density of 1:1 to 8:1 produced by reacting (A) an isocyanate-reactive component with (B) a polyisocyanate component and/or a polyisocyanate prepolymer component (C).

The isocyanate-reactive component (A) includes:
(A1) at least one polyether polyol with an OH value of from 10 to 100 and a functionality F of from 1.95 to 4,
(A2) at least one polyether polyol with an OH value of from 101 to 799 and a functionality F of from 1.95 to 6,
(A3) at least one crosslinker polyol with an OH value of from 800 to 1200 and a functionality F of from 2 to 4,
(A4) at least one chain extender which supports 1 to 2 alkylthio substituents on an aromatic ring and is derived from a toluene diamine, an aromatic diamine based on diphenylmethane or an aromatic polyamine based on higher homologs of diphenylmethane, and
(A5) optionally, diethyltoluene diamine (DETDA) and
(B) a polyisocyanate component which includes:
(B1) at least one monomeric diphenylmethane diisocyanate and
(B2) higher-nucleus homologs of diphenylmethane diisocyanates, and/or
(C) a polyisocyanate prepolymer produced from
(C1) at least one polyisocyanate based on a diphenylmethane diisocyanate and optionally the higher-nucleus homologs thereof,
(C2) and at least one polyether polyol.

By “knot density of the polyurea-polyurethane” (unit: [mol/kg]) is understood the number of trivalent, permanent chemical crosslinking points of the polyurea-polyurethane in moles per kilogram polyurea-polyurethane. For this, the quantities of all molecules of the starting raw materials of the polyurethane elastomer with a functionality higher than 2 are detected. In order to be able to treat all crosslinking points as trifunctional crosslinking points, the functionalities of higher-functional molecule types are evaluated differently: trifunctional molecules are evaluated at 1, tetrafunctional at 2, pentafunctional at 3, hexa-functional at 4, etc. According to this definition, a polyurethane composed of a polyol formulation made up of a polyether diol, 1,4-butanediol, triethanolamine and pentaerythritol foamed with a mixture of 1.21 wt. %, 2,4′-diphenylmethane diisocyanate and 98.79 wt. % 4,4′-diphenylmethane diisocyanate would have a knot density of 0.69 mol/kg, as the calculation in the following Table 1 shows by way of example.

The knot density of the polyurea-polyurethanes of the present invention is preferably not less than 0.6 mol/kg and does not exceed 3 mol/kg.

TABLE 1
Example for calculation of the knot density

| | | | | | Evaluated trifunctional | | Crosslinking |
|---|---|---|---|---|---|---|---|
| | | Molecular | | | crosslinking points per | Crosslinking points | points |
| Component | Weight [g] | weight [g/mol] | Quantity [mol] | Functionality | molecule | [mol/100 g] | [mol/kg] |
| Polyether diol | 35.47 | 3032.43 | 0.0117 | 2 | 0 | 0.000 | 0.00 |
| 1,4-Butanediol | 8.87 | 90.12 | 0.0984 | 2 | 0 | 0.000 | 0.00 |
| Triethanolamine | 4.43 | 149.20 | 0.0297 | 3 | 1 | 0.030 | 0.30 |
| Pentaerythritol | 2.66 | 136.20 | 0.0195 | 4 | 2 | 0.039 | 0.39 |
| MDI* | 48.57 | 250.75 | 0.1937 | 2 | 0 | 0.000 | 0.00 |

| | | | | |
|---|---|---|---|---|
| Total | 100.00 | Total | Crosslinking points = knot | 0.69 |
| | | [mol/kg] | density | |

*Mixture of 1.21 wt. % 2,4-diphenylmethane diisocyanate and 98.79 wt. % 4,4′-diphenylmethane diisocyanate

By “urea group density of the polyurea-polyurethanes” (unit: [mol/kg]) is understood the number of urea groups of the polyurea-polyurethane in moles per kilogram of the polyurea-polyurethane. With an equimolar mixture ratio of isocyanate and formulation, the number of urea groups is calculated from the single quantity of water molecules and the number of amines multiplied by their functionality. According to this definition, a polyurea-polyurethane which is produced by foaming a formulation composed of water, 6-methyl-2,4′-bis(methylthio)-phenylene-1,3-diamine, 1,4-butanediol foamed with a mixture of 1.21 wt. % 2,4′-diphenylmethane diisocyanate and 98.79 wt. % 4,4′-diphenylmethane diisocyanate, would have a urea group density of 2.24 moles urea groups per kilogram, as the calculation in Table 2 below shows by way of example.

TABLE 2
Example for calculation of the urea group density

| | | | | | Urea groups per |
|---|---|---|---|---|---|
| | | | | | weight polyurea- |
| | | Molecular weight | | Quantity of urea | polyurethane |
| Component | Weight [g] | [g/mol] | Quantity [mol] | groups [mol] | [mol/kg] |
| Water | 18.02 | 18.02 | 1.00 | 1.00 | 0.75 |
| 6-Methyl-2,4- | 214.35 | 214.35 | 1.00 | 2.00 | 1.49 |
| bis(methylthio)- | | | | | |
| phenylene-1,3-diamine | | | | | |
| 1,4-Butanediol | 90.12 | 90.12 | 1.00 | 0.00 | 0.00 |
| MDI* | 1002.99 | 250.75 | 4.00 | 0.00 | 0.00 |
| Carbon dioxide formed | 16.04 | 16.04 | 1.00 | | |
| Weight polyurea- | 1341.52 | | | | |
| polyurethane without | | | | | |
| carbon dioxide [g] | | | | | |
| Urea groups per weight | | | | | 2.24 |
| polyurea-polyurethane | | | | | |
| [mol/kg] | | | | | |

*Mixture of 1.21 wt. % 2,4′-diphenylmethane diisocyanate and 98.79 wt. % 4,4′-diphenylmethane diisocyanate

The present invention is also directed to a process for the production of polyurea-polyurethane molded articles which have a molar density ratio of knot density to urea group density of between 1:1 and 8:1. In this process, an isocyanate-reactive component (A) is reacted with (B) a polyisocyanate component and/or (C) a polyisocyanate prepolymer. Component (A) includes:
(A1) at least one polyether polyol with an OH value of 10 to 100 and a functionality F of from 1.95 to 4,
(A2) at least one polyether polyol with an OH value of 101 to 799 and a functionality F of from 1.95 to 6,
(A3) at least one crosslinker polyol with an OH value of 800 to 1200 and a functionality F of from 2 to 4,
(A4) at least one chain extender which supports 1 to 2 alkylthio substituents on an aromatic ring and is derived from toluene diamines, aromatic diamines based on diphenylmethane or aromatic polyamines based on higher homologs of diphenylmethane, and
(A5) optionally, diethyltoluene diamines (DETDA).

The polyisocyanate component (B) includes:
(B1) at least one monomeric diphenylmethane diisocyanate, and
(B2) at least one higher-nucleus homolog of the diphenylmethane diisocyanates.

The polyisocyanate prepolymer (C) is the reaction product of
(C1) at least one isocyanate based on a diphenylmethane diisocyanate and optionally, higher-nucleus homolog(s) thereof and
(C2) at least one polyether polyol.

The polyurea-polyurethane molded articles are preferably used in external parts for bodywork.

Component (B1) preferably includes 4,4′-diphenylmethane diisocyanate, optionally, 2,4′-diphenylmethane diisocyanate and optionally, 2,2′-diphenylmethane diisocyanate. The content of 4,4′-diphenylmethane diisocyanate is preferably from 70 wt. % to 100 wt. %, more preferably from 80 wt. % to 100 wt. % based on the total weight of component (B1). Component (B1) preferably has a content of from 50 wt. % to 100 wt. % of the total weight of the polyisocyanate component (B).

Component (B2) is made up of higher-nucleus homolog(s) of the diphenylmethane diisocyanates and preferably has a content of from 0 wt. % to 50 wt. % of the total weight of the polyisocyanate component (B).

The polyisocyanate prepolymer (C) is produced in a known manner by reacting the isocyanate component (C1), preferably at temperatures of approximately 80° C., with component (C2) to form the polyisocyanate prepolymer (C). In order to exclude secondary reactions due to atmospheric oxygen, the reaction vessel should preferably be flushed with an inert gas, preferably nitrogen.

The polyisocyanates (C1) used to produce the prepolymer (C) can preferably also contain levels of up to approximately 20 wt. % carbodiimide-modified, allophanate-modified or uretoneimine-modified monomeric diphenylmethane diisocyanates, carbodiimide groups and/or uretoneimine groups being preferred.

The polyether polyols (C2) are preferably polyether diols, most preferably, tripropylene glycol and/or dipropylene glycol. Component (C2) may, preferably, include long-chain polyether polyols with OH values between 10 and 100.

The quantity ratio of (C1) and (C2) is selected so that the NCO content of the prepolymer (C) is from 10 to 25 wt. %, preferably from 16 to 24 wt. %.

Component (A) includes:
(A1) at least one polyether polyol with an OH value of from 10 to 100,
(A2) at least one polyether polyol with an OH value of from 101 to 799,
(A3) at least one crosslinker polyol with an OH value of from 800 to 1200,
(A4) at least one chain extender which supports 1 to 2 alkylthio substituents on an aromatic ring and is derived from toluene diamines, aromatic diamines based on diphenylmethane or aromatic polyamines based on higher homologs of diphenylmethane, and
(A5) optionally, diethyltoluene diamines (DETDA).

Polyether polyols are used as component (A1) within the framework of this invention. They can be produced in accordance with known processes, for example, by polyinsertion via DMC catalysis of alkylene oxides, by anionic polymerization of alkylene oxides in the presence of alkali hydroxides or alkali alcoholates as catalysts and with addition of at least one starter molecule which contains 1 to 6, preferably 2 to 4 reactive hydrogen atoms, or by cationic polymerization of alkylene oxides in the presence of Lewis acids such as antimony pentachloride or boron fluoride etherate. Suitable alkylene oxides contain 2 to 4 carbon atoms in the alkylene radical. Water or 1- to 6-valent alcohols, such as ethylene glycol, 1,2-propanediol and 1,3-propanediol, diethylene glycol, dipropylene glycol, 1,4-ethanediol, glycerol, trimethylolpropane or even 2- to 4-valent amines, such as ethylenediamine, are suitable starter molecules. Suitable alkylene oxides include: tetrahydrofuran, 1,2-propylene oxide, 1,2- or 2,3-butylene oxide, preferably ethylene oxide and/or 1,2-propylene oxide. The alkylene oxides can be used singly, alternately in succession or as mixtures. Furthermore, ethylene oxide can be used in quantities of from 10 to 50% as ethylene oxide end block (“EO cap”) so that the polyols produced have predominantly primary OH end groups.

Polyether polyols (A1) preferably have a nominal functionality of from 1.95 to 4, preferably from 2 to 3 and most preferably 2. Furthermore, they have an OH value of from 10 to 100.

Polyether polyols (A2) preferably have a nominal functionality of from 1.95 to 6, preferably from 2 to 5. Furthermore, they have an OH value of from 101 to 799.

Crosslinker polyols (A3) preferably have a nominal functionality of from 2 to 4, preferably from 2 to 3. Furthermore, they have an OH value of from 800 to 1200.

The chain extender (A4) can be any of the aromatic diamines based on diphenylmethane or aromatic polyamines based on higher homologs of diphenylmethane, or toluene diamines. An additional feature of these amines is that they support 1 to 2 alkylthio substituents on their aromatic rings. Dialkylthiotoluene diamines which can also contain monoalkylthiotoluene diamines as secondary constituent are preferred. Particularly preferred are 3,5-dimethylthio-2,6-toluenediamine and 3,5-dimethylthio-2,4-toluene diamine and mixtures of these two materials.

The chain extender (A5) is a diethyltoluene diaamine (DETDA) which may optionally be used in mixture with the afore-mentioned chain extenders (A4).

Component (A) preferably contains from 1 wt. % to 25 wt. % of polyether polyol (A1) based on the total weight of components (A1) to (A5).

Component (A) preferably contains from 1 wt. % to 25 wt. % of polyether polyol (A2) based on the total weight of components (A1) to (A5).

Component (A) preferably contains from 1 wt. % to 25 wt. % of crosslinker polyether polyol (A3) based on the total weight of components (A1) to (A5).

Component (A) preferably contains from 1 wt. % to 25 wt. % of chain extender (A4) based on the total weight of components (A1) to (A5).

Component (A) preferably contains from 0 wt. % to 25 wt. % of chain extender (A5) based on the total weight of components (A1) to (A5).

The sum of components (A1) to (A5) is 100 wt. %.

In a preferred embodiment of the invention, in the reaction of component (A) with polyisocyanate (B) and/or polyisocyanate prepolymer (C), any of the additives from the following group can be added:

(A6) catalysts,

(A7) blowing agents,

(A8) fillers,

(A9) flame retardants,

(A10) release agents and

(A11) additives.

Additives (A6) to (A9) can be added both to component (A) and to component (B) and/or (C) or separately. They are preferably added to component (A).

Compounds which greatly accelerate the reaction of the compounds containing hydroxyl groups of components (A1) to (A3) with the polyisocyanate groups in particular are used as catalysts (A6) for the production of the polyurea-polyurethane.

Tin(II) compounds such as tin(II)-bis(2-ethylhexanoate), dibutyl tin dilaurate, dibutyltin bis(dodecanoate), dibutyltin oxide, dibutyltin sulfide, dibutyltin bis(dodecylthiolate), dibutyltin dilauryl mercaptide, or even other metal salts such as bismuth(III) carboxylic acid salts, titanium(IV) salts, alkoxylates and those with acetylacetonato ligands, for example, are suitable. The metal compounds are usually used in combination with strongly basic amines. Such amines include: 1,8-diazabicyclo[5,4,0]undec-7-ene, 1-methylimidazole, bis-(2-dimethylamino-ethyl)-ether, dimethylcyclohexylamine, N,N-dimethylbenzylamine, bis(2-dimethylaminoethyl)methylamine and, preferably, 1,4-diazobicyclo(2,2,2)-octane (DABCO).

Compact or microcellular polyurea-polyurethanes are preferably produced in accordance with the process of the present invention. Water which reacts with isocyanates in situ forming carbon dioxide and amino groups which for their part further react with other isocyanate groups to form urea groups and thereby act as chain extenders, is preferably used as blowing agent (A7). Other chemical blowing agents such as ammonium carbamate or ammonium salts of organic carboxylic acids, gases or highly volatile inorganic or organic substances can be used instead of water or in combination with water as physical blowing agents. Acetone, ethyl acetate, halogen-substituted alkanes or partly-halogenated alkanes (such as R134a, R141b, R365mfc, and R245fa), and also butane, pentane, cyclopentane, hexane, cyclohexane, heptane or diethylether are examples of suitable organic blowing agents. Suitable inorganic blowing agents include: air, CO₂ and N₂O.

Reinforcing materials such as aluminum oxide and titanium oxide can be used as fillers (A8). Reinforcing silicates such as serpentine, antigorite, chrysotile, kaolinite, halloysite, talc, pyrophyllite, saponite, montmorillonite, biotite, muscovite, phlogopite and brucite are preferably used. Natural fibers such as wollastonite, erionite, attapulgite, sipiolite, flax and hemp, and synthetically produced fibers such as carbon fibers, glass fibers or quartz fibers are particularly preferred.

The fillers (A8) are usually used in quantities by weight of from 1 to 50 wt. % based on the total weight of the polyurea-polyurethane. The total weight is obtained from the individual weights of the components and additives (A1) to (A10) and (B) and/or (C).

Suitable flame retardants (A9) include halogenated polyether polyols such as ixol. Halogenated phosphates such as tricresyl phosphate, tris-2-chloroethyl phosphate, tris-chloropropyl phosphate and tris-2,3-dibromopropyl phosphate, are also suitable. Solid inorganic and organic flame retardants, such as aluminum oxide hydrate, ammonium polyphosphate, melamine and red phosphorus can also be used. The flame retardants are usually used in quantities by weight of from 1 to 25 wt. % based on the total weight of the polyurea-polyurethane.

Additives optionally to be used (A11) are surface-active substances, foam stabilizers, inhibitors, cell regulators, dyes, coupling agents, antioxidants and pigments, and release agents (A10) are described in the specialist literature, for example in “Kunststoff-Handbuch”, volume 7 “Polyurethane”, Guinter Oertel, Carl-Hanser Verlag, Munich—Vienna, revised edition 1993, chapter 3.4.

Component (A) is in general mixed with polyisocyanate (B) and/or with isocyanate prepolymer (C) in an amount such that the molar equivalence ratio of NCO groups to isocyanate-reactive groups in component (A) is from 1:0.8 to 1:1.3. Preferably, component (A) is mixed both with polyisocyanate (B) and/or isocyanate prepolymer (C) in a molar equivalence ratio of 1:1.

Components (A) and (B) or (C) can be mixed in a low-pressure or high-pressure process. The high-pressure process, also called the RIM (reaction injection moulded article) process, is preferred.

Heated epoxide molds or preferably heated aluminum molds and steel molds can be used as closed molds. The mold temperature should be between 55° C. and 120° C., preferably 70° C. to 95° C., most preferably between 71° C. and 79° C. The mold dwell time can be a minimum of 90 seconds. Mold dwell times above 2 minutes are particularly preferred.

Component (A), polyisocyanate (B) and/or isocyanate prepolymer (C) are heated to temperatures between 15° C. and 80° C. Temperatures between 20° C. and 50° C are preferred.

High-pressure machines optimally mix the starting materials of polyurea-polyurethane systems depending on the size of the mixing chamber, the mixing head and the high-pressure pumps only in a certain range of minimum and maximum discharge performance. Producers must therefore balance optimal mixing and discharge performance. If the discharge performance of a machine-specific threshold value is not achieved, the components are insufficiently mixed. It would then have to be processed in a smaller machine. If large molded articles have to be filled, machines with a high discharge performance which are inadequate for mixing polyurea-polyurethanes systems for small parts are required for the rapid polyurea-polyurethane systems used to produce the large articles.

An advantage of the process according to the invention is that its polyurea-polyurethanes systems can be metered for long periods. Consequently both small parts and also large parts can be manufactured with optimum mixing using machines with a small discharge performance. This simplifies production planning and reduces investment costs for the high-pressure machines. In general, the shot times in the process of the present invention are between 6 seconds and 40 seconds, preferably from 10 sec to 25 sec. Conventional systems which correspond to the prior art, such as those which are commercially available under the names Bayflex® 190, Spectrim® HH 390 or Elastolit® R, usually have shot times of less than 4 seconds.

For the most part, an individual physical property does not sufficiently characterise a material. In general, it means that several different properties meet certain minimum requirements at the same time. The polyurea-polyurethanes of the present invention exhibit a particularly advantageous combination. They have a heat distortion temperature according to DIN EN ISO 75-2 of at least 100° C. without requiring heating. In addition, they have a high impact strength in accordance with DIN EN ISO 179 of at least 100 kJ/m². Further, flexural moduli in accordance with DIN EN ISO 178 of at least 2000 N/mm² are achieved without the use of abrasive fillers.

The invention will be explained in greater detail by means of the following examples.

### EXAMPLES

In the following Examples 1 and 2, polyurea-polyurethane systems according to the invention were used. Examples 3 to 8 are comparative.

The following components were used as starting compounds:

| | | | | | | Molecular |
|---|---|---|---|---|---|---|
| | Structure | | | OH value | F | weight |
| Component 1 | TMP | 20.3 | wt. % | ~255 | 3 | ~220 |
| (A2) | PO | 0.877 | wt. % | | | |
| | EO | 78.82 | wt. % | | | |
| Component 2 | 1,2-PG | 1.9 | wt. % | ~28 | 2 | ~2000 |
| (A1) | PO | 68.67 | wt. % | | | |
| | EO | 29.43 | wt. % | | | |
| Component 3 | EDA | 16.87 | wt. % | ~630 | 4 | ~90 |
| (A2) | PO | 83.13 | wt. % | | | |
| Component 4 | TMP | 82.01 | wt. % | ~1030 | 3 | ~55 |
| (A3) | PO | 17.99 | wt. % | | | |
| Component 5 | Ethacure ® 300 | | | ~525 | 2 | ~110 |
| (A4) | chain extender | | | | | |
| Component 6 | 1,2-PG | 2.02 | wt. % | ~45 | 2.3 | ~1250 |
| (A1) | TMP | 1.21 | wt. % | | | |
| | PO | 96.76 | wt. % | | | |
| Component 7 | DETDA | | | ~630 | 2 | ~180 |
| (A5) | | | | | | |
| Component 8 | TMP | 1.543 | wt. % | ~28 | 6 | ~11800 |
| (A1) | PO | 81.13 | wt. % | | | |
| | EO | 17.33 | wt. % | | | |
| Component 9 | Butyl | 17.9 | wt. % | ~85 | 1 | ~660 |
| (A1) | glycol | | | | | |
| | PO | 82.1 | wt. % | | | |

| | | | | |
|---|---|---|---|---|
| Additive 1 | Water | 6228 | 2 | 18 |
| (A7) | | | | |
| Additive 2 | Tegostab ® B8411 | ~100 | 2 | ~11000 |
| | stabilizer | | | |
| Additive 3 | Edenor ® TI 05 ester | ~200 | 1 | ~280 |
| Additive 4 | Diazabicyclooctane | ~550 | 2 | |
| (A6) | | | | |
| Additive 5 | Poly- | ~255 | 2 | ~440 |
| | oxypropylenediamine | | | |

| Isocyanate 1 | 87 wt. % 4,4′-MDI and 13 wt. % TPG; | | |
|---|---|---|---|
| | NCO content approx. 23 wt. % | | |
| Isocyanate 2 | NCO content 31.5 wt. % | | |
| | 44 | wt. % | 4,4′-MDI |
| | 4 | wt. % | 2,4′-MDI |
| | 1 | wt. % | 2,2′-MDI |
| | 30 | wt. % | 3 nucleus MDI |
| | 13 | wt. % | 4 nucleus MDI |
| Isocyanate 3 | NCO content 31.5 wt. %; prepolymer composed | | |
| | of 94.5 wt. % MDI and 5.5 wt. % of a PG started polyether | | |
| | (with PO) with an OH value of approx. 510. | | |
| | MDI: | | |
| | 75 | wt. % | 4,4′-MDI |
| | 8 | wt. % | 2,4′-MDI |
| | 0.4 | wt. % | 2,2′-MDI |
| | 17 | wt. % | 3 nucleus and 4 nucleus MDI |
| Isocyanate 4 | NCO content 15.5 wt. %; prepolymer | | |
| | composed of 53 wt. % MDI and | | |
| | 47 wt. % of a glycerol started polyether (with EO) with | | |
| | an OH value of approx. 48. | | |
| | MDI: | | |
| | 80 | wt. % | 4,4′-MDI |
| | 10 | wt. % | 2,4′-MDI |
| | 0.5 | wt. % | 2,2′-MDI |
| | 10 | wt. % | higher functional MDI |

TMP = trimethylolpropane
PO = propylene oxide
EO = ethylene oxide
PG = propylene glycol
EDA = ethylenediamine
DETDA = diethyltoluene diamine
Ethacure ® 300 = dimethylthiotoluene diamine
Tegostab ® B 8411 = polyether polysiloxane copolymer foam stabilizer
Edenor ® TI 05 = fatty acid ester (Cognis)
MDI = diphenylmethane diisocyanate

TABLE 3
Formulae for component (A) in percentages by weight

| | Examples | | | | | | | | |
|---|---|---|---|---|---|---|---|---|---|
| | 1 | 2 | 3 | 4 | 5 | 6 | 7a | 8 | 7b*⁾ |
| Component 1 | 15.18 | 15.18 | 18.21 | — | — | — | 15.18 | — | 15.18 |
| Component 2 | 15.01 | 15.01 | 21.76 | 9.89 | 9.89 | 88.15 | 15.01 | — | 15.01 |
| Component 3 | 6.09 | 6.09 | 7.30 | 89.02 | 89.02 | 9.79 | 6.09 | — | 6.09 |
| Component 4 | 33.78 | 33.78 | 40.52 | — | — | — | 33.78 | — | 33.78 |
| Component 5 | 17.26 | 17.26 | — | — | — | — | 17.26 | — | 17.26 |
| Component 6 | 2.5 | 2.5 | — | — | — | — | — | — | — |
| Component 7 | — | — | — | — | — | — | 17.26 | 41.5 | 17.26 |
| Component 8 | — | — | — | — | — | — | — | 46.39 | — |
| Component 9 | 6.70 | 6.70 | 8.04 | — | — | — | 6.70 | — | 6.70 |
| Additive 1 | 0.16 | 0.16 | 0.19 | 0.1 | 0.1 | 0.1 | 0.16 | — | 0.16 |
| Additive 2 | 0.79 | 0.79 | 0.95 | 0.99 | 0.99 | 0.98 | 0.79 | 0.88 | 0.79 |
| Additive 3 | 1.70 | 1.70 | 2.04 | — | — | — | 1.70 | | 1.70 |
| Additive 4 | 0.83 | 0.40 | 1.00 | — | — | 0.98 | 0.40 | — | 0.40 |
| Additive 5 | — | — | — | — | — | — | — | 0.7 | — |
| Total | 100 | 100 | 100 | 100 | 100 | 100 | 100 | 100 | 100 |

*⁾The product from test 7a was heated for two hours at 80° C. directly after production.

TABLE 4
Composition of the polyurethanes in parts by weight

| | Examples | | | | | | | | |
|---|---|---|---|---|---|---|---|---|---|
| | 1 | 2 | 3 | 4 | 5 | 6 | 7a | 8 | 7b¹⁾ |
| Compo- | 100 | 100 | 100 | 100 | 100 | 100 | 100 | 100 | 100 |
| nent (A) | | | | | | | | | |
| Isocya- | 178 | — | 178 | 187 | — | 32 | 189 | — | 189 |
| nate 1 | | | | | | | | | |
| Isocya- | — | — | — | — | 136 | — | — | — | — |
| nate 2 | | | | | | | | | |
| Isocya- | — | 145 | — | — | — | — | — | — | — |
| nate 3 | | | | | | | | | |
| Isocya- | — | — | — | — | — | — | — | 150 | — |
| nate 4 | | | | | | | | | |

¹⁾The product from test 7a was heated for two hours at 80° C. directly after production.

Component (A) was in each case mixed with an isocyanate or prepolymer at high pressure and injected into a closed mold with a mold temperature of 75° C. The molar equivalence ratio of NCO groups of the isocyanate or prepolymer to such groups of component (A) that react with isocyanates is thereby set at 1:1. The finished molded articles (test pieces) were demolded after a mold dwell time of 3 minutes. The properties (see Table 5) were measured on the test pieces.

TABLE 5
Properties of the polyurethanes

| | | | | | | | Number of | | |
|---|---|---|---|---|---|---|---|---|---|
| | | | | | | | unbroken test | | |
| | | | | | | | pieces | | |
| | Molded | | | Knot | HDT [° C.] | Mean impact strength [kJ/m²] | acc. To DIN EN | | Setting |
| | article | Knot | Urea | density/ | according | acc. to DIN EN ISO 179 | ISO 179 with a | Flexural modulus | time |
| | density | density | content | urea | to DIN | of broken test pieces of a total | total test piece | [N/mm²] | (machine) |
| Example | [kg/m³] | [mol/kg] | [mol/kg] | density | EN ISO 75-2 | quantity of 10 test pieces | quantity of 10 | DIN EN ISO 178 | [sec] |
| 1 | 1127 | 0.88 | 0.634 | 1.4 | 102 | Not | 10 | 2552 | 18 |
| | | | | | | broken | | | |
| 2 | 1087 | 1.64 | 0.724 | 2.3 | 113 | 100 | 0 | 2310 | 17 |
| 3 | 1030 | 1.07 | 0.064 | 16.7 | 85 | 45 | 0 | 2105 | 20 |
| 4 | 1100 | 1.75 | 0.019 | 92.1 | 100 | 36 | 0 | 2570 | 20 |
| 5 | 1090 | 3.46 | 0.023 | 150.4 | 124 | 13 | 0 | 2620 | — |
| 6 | 1000 | 0.42 | 0.041 | 10.2 | ¹⁾ | Not | 10 | ²⁾ | 50 |
| | | | | | | broken | | | |
| 7a | 1200 | 0.88 | 0.743 | 1.2 | 108 | 114 | 3 | 2830 | 1 |
| 8 | 1125 | 0.33 | 2.097 | 0.15 | 153 | Not | 10 | 476 | 1 |
| | | | | | | broken | | | |
| 7b | 1200 | 0.88 | 0.743 | 1.2 | 112 | 101 | 7 | 2680 | 1 |

¹⁾No HDT measurement possible because the test pieces were too flexible. The test pieces bend without any increase in temperature.
²⁾Measurement not possible because this material is not, as required in standard DIN EN ISO 178, a rigid plastic.
HDT = heat distortion temperature

The polyurea-polyurethanes according to the invention of (Examples 1 and 2) have molar density ratios of 1.4 and 2.3 and high HDT values of 102° C. and 113° C. At the same time, these products have high impact strengths of ≧100 kJ/m² or they do not break. In addition, they have very high flexural moduli of 2525 N/mm² or 2310 N/mm². These properties are noteworthy against the background of the long setting times of these systems which allow even large cavities to be filled sufficiently rapidly with high-pressure units with comparatively low discharge performance.

The polyurea-polyurethanes not according to the invention do not meet these requirements. Thus the products of Comparative Examples 3, 4 and 5 have too high molar density ratios of between 16 and 150. These products have in fact respectable flexural moduli of up to 2620 N/mm², but the impact strengths fall by 50% and more compared with Examples 1 and 2.

The very flexible product of Comparative Example 6 is in fact attractive due to very high impact strength (it does not break) and very slow start time of 50 sec, but its rigidity is completely unsatisfactory. The molar density is moreover insufficient. It has a similar behavior to the product from Comparative Example 8. Its molar density is likewise insufficient. The setting time at approximately 1 second is much too rapid to fill large parts with low machinery expenditure. Moreover, the flexural modulus is much too low.

The product from Comparative Example 7a was measured unheated. The same system was heated and then measured (Comparative Example 7b). The properties of both test pieces were in fact good, but these good properties could only be achieved by very short reaction times. Use for large molded articles is therefore excluded.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a polyurea-polyurethane molded article having a molar density ratio of knot density to urea group density of from 1:1 to 8:1 comprising reacting in a mold an isocyanate-reactive component (A) with a polyisocyanate component (B) and/or a polyisocyanate prepolymer (C), in which isocyanate-reactive component (A) comprises:
(A1) at least one polyether polyol with an OH value of from 10 to 100 and a functionality of from 1.95 to 4,
(A2) at least one polyether polyol with an OH value of from 101 to 799 and a functionality of from 1.95 to 6,
(A3) at least one crosslinker polyol with an OH value of from 800 to 1200 and a functionality of from 2 to 4,
(A4) at least one chain extender which supports from 1 to 2 alkylthio substituents on an aromatic ring and is derived from a toluene diamine, an aromatic diamines based on diphenylmethane or an aromatic polyamine based on a higher homolog of diphenylmethane, and
(A5) optionally, a diethyltoluene diamine (DETDA),
polyisocyanate component (B) comprises:
(B1) a monomeric diphenylmethane diisocyanate and
(B2) a higher-nucleus homolog of diphenylmethane diisocyanate,
and polyisocyanate prepolymer (C) comprises a reaction product of
(C1) an isocyanate based on diphenylmethane diisocyanate and optionally, one or more higher-nucleus homologs thereof, and
(C2) a polyether polyol.

2. The process of claim 1 in which at least one of
(A6) a catalyst,
(A7) a blowing agent,
(A8) a filler,
(A9) a flame retardant,
(A10) a release agent or
(A11) an additive
is included in component (A) or component (B) or component (C).

3. The process of claim 1 in which a dimethylthiotoluene diamine is used as chain extender (A4).

4. The process of claim 1 in which the knot density of the polyurea-polyurethane is not less than 0.6 mol/kg and does not exceed 3 mol/kg.

5. The process of claim 1 in which the molar ratio of NCO groups of component (B) and/or (C) to the isocyanate-reactive functional groups of components (A1) to (A5) is between 1:0.8 to 1:1.3.

6. A polyurea-polyurethane molded article produced by the process of claim 1.
